(19) United States
(12) Patent Application Publication
(10) Pub. No.: US 2021/0324679 A1
(43) Pub. Date: Oct. 21, 2021

(54) WINDOW ASSEMBLY INCLUDING SLATS

(71) Applicant: CROPSS HOLDING B.V., Andijk (NL)

(72) Inventor: Jacobus Christiaan Gerardus Maria RUITER, Zoetermeer (NL)

(21) Appl. No.: 17/272,511

(22) PCT Filed: Aug. 30, 2019
(86) PCT No.: PCT/NL2019/050560

§ 371 Date: Mar. 1, 2021

(30) Foreign Application Priority Data
Aug. 30, 2018 (NL) 2021524

(51) Int. Cl. E06B 9/264

(52) U.S. Cl. CPC E06B 9/264; E06B 2009/2464; E06B 2009/2643

(57) ABSTRACT

Disclosed is a window assembly with slats, including a first window, defining a surface; a first layer, conductive and adhered to a first side of the first window; an added window, connected to the first window at the first side, extending parallel to the first window; wherein a second layer is adhered to the added window, the second layer being conductive and adhered to a first side of the added window; and wherein the first layer or the second layer includes slats which are conductive and movable between a first position in which the slats extend substantially parallel to the surface, and a second position in which the slats are oriented substantially perpendicular to the surface; and wherein the first layer and the second layer are connectable to a voltage source for applying a voltage difference between the first layer and the second layer, so the slats are movable.

### TECHNICAL FIELD

The invention relates to a window assembly including slats disposed in between two layers. The invention further relates to an added window assembly, and to an assembly of slats. Furthermore, the invention relates to a method for replacing slats in a window assembly.

### BACKGROUND ART

Windows with blinds or strips or slats disposed in between transparent layers are known in the art. Such windows can be used in many different situations: in roofs for greenhouses, regular glazing, advertising, light domes, atriums, conservatories, verandas, camper or caravan windows or special architecture. The slats can be tilted in order to control the amount of (solar) radiation passing through the windows, so as to regulate the temperature and light level in the space bound by the window.

WO 2008/041848 shows a strip assembly disposed between transparent layers, wherein the strips comprise electrodes and a grid of electrodes with different polarity is provided in between the strips. The electrodes can enable an electrostatic attracting or repulsive force between the strips so as to control the orientation of the strips.

Although the described strip assembly is useful, it requires a complicated wiring of electrodes and is difficult to manufacture and to maintain.

It would be desirable to provide a window assembly which removes or reduces at least some of the inconveniences of the prior art.

### SUMMARY OF THE INVENTION

According to an aspect of the invention, there is provided a window assembly with slats, comprising a first window, defining a surface; a first layer, conductive and adhered to a first side of the first window; an added window, connected to the first window at the first side, extending parallel to the first window; wherein a second layer is adhered to the added window, the second layer being conductive and adhered to a first side of the added window which faces the first layer; and wherein the first layer or the second layer comprises slats which are conductive and movable between a first position in which the slats extend substantially parallel to the surface, and a second position in which the slats are oriented substantially perpendicular to the surface, and are positioned in between the first layer and the second layer; and wherein the first layer and the second layer are connectable to a voltage source for applying a voltage difference between the first layer and the second layer, such that the slats are movable.

The window assembly according to the invention is very easy to manufacture compared to the prior art. The adhesive first and second layers can be prepared and manufactured in advance and can be quickly adhered to the first window and the added window. The assembly time at the location of the window is thus reduced to a minimum. Some known window assemblies require conductive coatings on the windows, which needs to be milled away at the edges to avoid electrical breakdowns. Since the window assembly of the present invention uses adhesive first and second layers, it does not require conductive coatings on the windows, such that milling away the coatings at the edges is not needed. This improvement thus saves time and resources.

Preferably, the first window and added window each predominantly comprise a transparent or translucent plate, which may be made of glass or plastic. The typical materials used for windows (i.e. window panes) will be known to a person skilled in the art. The first window preferably is an existing window which may be already mounted in a frame. It may be a single transparent layer, but it may also be a double or triple layer (i.e. double glazing or triple glazing). The transparency of the windows may relate to only a part of the electromagnetic spectrum from ultraviolet to far infrared. In particular, it may be transparent only for visible and IR radiation, or only for visible and UV radiation. The windows may alternatively be only transparent to a certain colour or certain colours. The first window and added window may be of the same transmittance, but this may also be different. In an embodiment, one of the first window and added window is a non-transparent plate, such that the window assembly can be used for blocking or reflecting thermal radiation.

The added window may have the same height and width as the first window. Alternatively, the added window may have a smaller height and/or a smaller width than the first window.

One of the first and second layers comprises slats. The slats have the shape of parallel strips. The slats may be partially cut from the respective layer (e.g. at one long side and two short, perpendicular side of each slat), or may be adhered to the remainder of this layer. The slats may be printed or patterned. The layer including the slats is conductive over its entire area. However, the side which is adhered to the first or added window may be insulating or conductive. Preferably, the layer comprising the slats is releasably adhered to the first window or the added window, such that it can be removed and/or replaced in one piece if needed. The slats are preferably connected to this layer in a hinging manner with a hinge edge at an upper side, such that the slats hang downwards due to gravity when no voltage is applied. When the window assembly is mounted in a tilted manner, the slats may be arranged at the upper one or at the lower one of the first window and added window. When they are arranged at the upper one of the first window and the added window, they hang downwards when no voltage is applied. When they are arranged at the lower one of the first window and the added window, they hang partially downwards while extending along and resting on the lower one of the first window and the added window when no voltage is applied. The planar, non-movable part of the layer which includes the slats may be flexible or inflexible. The slats themselves may be flexible too. In an embodiment, the slats are at a long side attached to a planar conductive layer, such that the slats and the planar conductive layer together form the first or second layer.

In this context, substantially parallel to the surface means a mutual angle of less than 5 degrees, preferably less than 2 degrees between the surface of the slat and the layer, measured at the hinge edge. Substantially perpendicular to the surface means a mutual angle of between about 85 and 90 degrees. The edge of the slats around which the slats hinge is preferably horizontal. Alternatively, this edge may be tilted with respect to a horizontal line, preferably under an angle of between 0 and 80 degrees.

One of the first and second layer does not comprise the slats. This layer is insulating at one side, and entirely conductive at the other side. This layer is adhered to the first window or the added window with the conductive side, which is provided with an adhering layer. This layer may be flexible. The first layer and the second layer—both the one with slats and the one without slats—may be flexible to improve their installation at the first window and the added window. ‘Flexible’ means that it can be bent without breaking. They may be supplied on a roll and/or cut to size. Their shape is preferably rectangular, but it may be any other shape, such as circular or polygonal. They may be applied to only part of the first window or added window.

Many different types of slats can be conceived. The slats may be blocking, reflecting or converting ultraviolet (UV), visible and infrared (IR) radiation, or they may selectively block, reflect or convert only a specific range of the electromagnetic spectrum, e.g. only UV or only IR. The slats may be very thin to allow them to move with respect to the first or second layer without a designated hinge (i.e. when the slats are flexible and hinge themselves). The thickness of the slats may be less than 20 micron, preferably between 5 and 10 micron, more preferably about 6 micron. Alternatively, the slats may be thicker or much thicker, e.g. about 25 micron, and hinges may be used to allow the slats to hinge or move relative to the first or second layer. The slats are conductive, preferably with a sheet resistance of between 10-100 MO (mega-ohm). The slats may be made conductive by means of deposition of a conductive thin film (e.g. vacuum, electrostatic or chemical deposition), lacquer or surface modification. When the slats are in their first position, i.e. when they extend along the surface, they may either overlap one another, or they may not overlap one another and leave a space in between them. Alternatively, the slats may (in their first position) just touch one another and form an uninterrupted surface together. The slats may have the same optical transmittance as the layer in which it is comprised, or it may have a different optical transmittance. The slats may be woven from cotton or polymer fibres, and after weaving enriched with a conductive coating. When the slats are flexible they may be slightly bended.

The voltage source is preferably a transformer which is connected to a mains voltage. The transformer converts the mains voltage to a designated voltage that is suited for the window assembly with slats. Alternatively, the voltage source may be a battery, which is preferably charged by means of renewable energy such as solar cells. The slats move on the basis of electrostatics, under applied voltages of typically 0-10 kV. The first layer and second layer may be arranged with first and second busbars which serve to connect them to the voltage source. Preferably, the components bearing the high voltage, such as slats, first and second layer, busbars and wires, are entirely enclosed by the windows or by the frame when the added window is in place, for safety reasons.

The space in between the first window and the added window does not need to be hermetically sealed from the external environment and may be at atmospheric pressure. This has the advantage that temperature in between the first window and the added window will be not much higher than the external environment. In this way the material requirements for the slats do not need to be very strict, e.g. because there is not a need to withstand extremely high temperatures.

The window assembly may be mounted such that its surface extends vertically. Alternatively, the window assembly may be mounted in a tilted manner, at an angle of between 5 degrees and 90 degrees with respect to the horizontal. The window and added window may be planar such that the surface is a planar surface. Alternatively, the window assembly may be bended or curved, in particular it may have the shape of a part of a cylinder surface.

In an embodiment, the added window is releasably connected to the first window.

Known window assemblies utilize a vacuum or low pressure in between the different windows, such as in a usual ‘double glazing’ assembly, because this prevents contamination or moisture in between the windows. This comes with the disadvantage that it is virtually impossible to reach the slats for maintenance (e.g. to repair a broken slat or electrode) or replacement (e.g. when different slats are desired). Furthermore, in known double glazing assemblies the space in between the windows may become extremely hot (up to 90 degrees Celsius), which severely limits the design freedom of the slats and electrodes.

Being able to release the added window from the first window allows for easy access to the space in between, and thus to the slats, and allows for easy maintenance, replacement and/or removal of the slats. This set-up does not require to replace the entire window assembly. Replacement of slats is useful when slats are broken, or when slats with different optical transmittance are required, for example in a greenhouse, when different crops or flowers are to be grown, or in advertising when a different visual appearance is desired. In this way costs are reduced.

In this context, a releasably connected window refers to a window being connected while it is possible to be released without damaging anything. In other words, the added window is adapted to be released from the first window, and comprises provisions to separate the two. These provisions may be any type of hinges, allowing the added window to pivot away from the first window. Alternatively, the provisions may be fastening material such as bolt-nut connections. A person skilled in the art will understand that there are many mechanical alternatives which allow for a strong connection which can be regularly disconnected. The provisions are specifically designed to release the added window from the first window on a regular basis.

In an embodiment, the voltage difference is variable between 0 V and a maximum voltage, enabling intermediate positioning of the slats. In this way, also orientations in between parallel and perpendicular are possible; the slats can be oriented at any angle in between the two extremes. The maximum voltage may be at least 1 kV, preferably at least 5 kV, more preferably about 10 kV.

In an embodiment, the first layer or the second layer, whichever is opposite to the slats, is provided with an insulating sublayer covering a surface facing the slats. The insulating sublayer has the advantage that sparks or voltage breakdowns are avoided.

In an embodiment, the added window is hingedly connected to the first window.

Using hinges the added window can be released from the first window, such that their first (inner) sides can be approached. Hinges allow for an easy and non-damaging release of the added window, which allows the slats to be replaced/maintained on a regular basis when the added window is in a position that allows access to the slats. The added window may be inflexible.

In an embodiment, the window assembly further comprises a functional layer, for instance a PDLC (Polymer Dispersed Liquid Crystal) layer or a ferro-electric layer.

The functional layer is adapted to actively modify the light going through. The functional layer may be adapted to only modify a specific part of the electromagnetic spectrum, e.g. only IR, visible or UV radiation.

In an embodiment, the functional layer is provided between the first window and the first layer, and the window assembly is further provided with an extra functional layer, for instance a PDLC layer or a ferro-electric layer, wherein the extra functional layer is provided between the added window and the second layer.

In an embodiment, the functional layer is provided between the first window and the first layer or between the added window and the second layer.

In an embodiment, the functional layer is a PDLC layer, which is at both lateral sides provided with electrodes for exerting an electric field across the PDLC layer, wherein the electric field is adapted to shift an optical transmittance of the PDLC layer between transparent and opaque. When no voltage is applied, the PDLC layer is typically opaque.

The shifting from transparent to opaque may be gradual. The electric field may be applied by DC voltage. However, also AC voltage may be suitable, depending on manufacturer specifications.

In an embodiment, the voltage source is provided on the first window or on the added window. This has the advantage that the windows together form a complete assembly which can operate independently. Alternatively, the voltage source is provided externally.

In an embodiment, the slats are adapted to entirely or partially block, reflect or convert at least one of visible light, infrared radiation and ultraviolet radiation.

According to an aspect of the invention, and in accordance with the advantages and effects described herein, there is provided an added window assembly, comprising an added window and a second layer, adapted for application in a window assembly, preferably as described herein, wherein the second layer is conductive and adhered to the added window, and wherein the added window comprises slats which are conductive and movable between a first position in which the slats extend substantially parallel to the added window, and a second position in which the slats are oriented substantially perpendicular to the added window.

According to an aspect of the invention, and in accordance with the advantages and effects described herein, there is provided an assembly of conductive slats provided with an adhesive second layer, adapted to be used in a window assembly, preferably as described herein.

According to an aspect of the invention, and in accordance with the advantages and effects described herein, there is provided a method for applying slats to a first window, comprising the steps of
providing a first window provided with a conductive first layer at a first side of the first window, and providing an added window provided with a conductive second layer at a first side of the added window,

wherein the first layer or the second layer is provided with slats which are conductive and are, as a result of the voltage difference, movable between a first position wherein the slats substantially extend in a surface, and a second position wherein the slats are oriented substantially perpendicular to the surface, and are positioned in between the first layer and the second layer;
placing the added window parallel to the first window, wherein the first side of the added window faces the first side of the first window;
connecting the first layer and the second layer to a voltage source for regulating a voltage difference between the first and the second layer.

In an embodiment, the method for applying slats to a first window further comprises, prior to the already described steps, the following steps:
providing the first window;
applying the first layer to the first side of the first window;
providing the added window;
applying the second layer to the first side of the added window.

According to an aspect of the invention, and in accordance with the advantages and effects described herein, there is provided a method for replacing slats in a window assembly, preferably as described herein, comprising the steps of:
releasing and removing the added window;
removing the first or second layer, whichever is provided with the slats;
applying a new first layer to the first window or a new second layer to the added window, wherein the new first layer or the new second layer comprises slats;
replacing the added window in its original position.

In this method replacing the slats requires replacing only the layer provided with slats. The layer without the slats can thus stay in place. In an embodiment, the surface is a planar surface.

According to an aspect of the invention, and in accordance with the advantages and effects described herein, there is provided a window assembly with slats, comprising a first window, defining a surface; a first layer, conductive and adhered to a first side of the first window; an added window, connected to the first window at the first side, extending parallel to the first window; wherein a second layer is adhered to the added window, the second layer being conductive and adhered to a first side of the added window which faces the first layer; and wherein the first layer or the second layer comprises slats which are conductive and movable between a first position in which the slats extend substantially parallel to the surface, and a second position in which the slats are oriented substantially perpendicular to the surface, and are positioned in between the first layer and the second layer; and wherein the first layer and the second layer are connectable to a voltage source for applying a variable voltage difference between the first layer and the second layer, such that the slats are movable; and wherein the window assembly further comprises at least one functional layer, for instance a PDLC layer or a ferro-electric layer, wherein the functional layer is provided between the first window and the first layer and/or between the added window and the second layer.

The various aspects discussed in this patent can be combined in order to provide additional advantages.

### BRIEF DESCRIPTION OF DRAWINGS

Embodiments will now be described, by way of example only, with reference to the accompanying schematic drawings in which corresponding reference symbols indicate corresponding parts.

FIG. 1 shows a partial cross-section of a window assembly including frame according to an embodiment.

FIG. 2a shows a partial cross-section of a window assembly according to an embodiment;

FIG. 2b shows a partial cross-section of a window assembly according to an alternative embodiment;

FIG. 3a-b show partial cross-sections of window assemblies with a functional layer according to embodiments;

FIG. 4a-b show partial cross-sections of window assemblies with a functional layer according to embodiments;

FIG. 5 shows a partial cross-section of a window assembly with two functional layers according to an embodiment;

FIG. 6 shows a partial cross-section of a window assembly with two functional layers according to an embodiment.

The figures are meant for illustrative purposes only, and do not serve as restriction of the scope or the protection as laid down by the claims.

### DETAILED DESCRIPTION

Further advantages, features and details of the present invention will be explained in the following description of some embodiments thereof. In the description, reference is made to the attached figures.

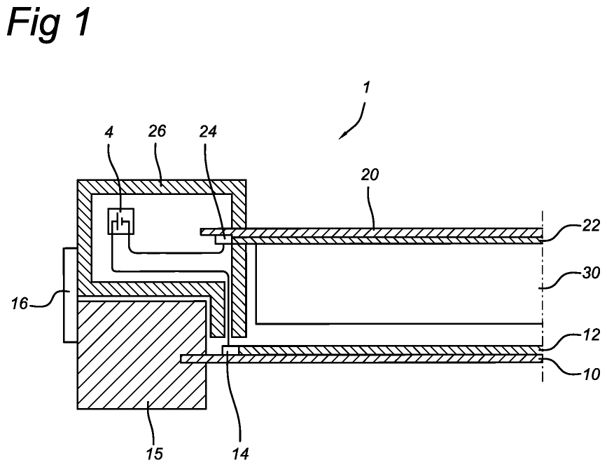

FIG. 1 schematically shows a part of a cross-section (top view) of a window assembly 1 according to the invention. The window assembly 1 comprises a first window 10, which is formed by a transparent layer mounted in a first frame 15. On the first window 10, a conductive first layer 12 is applied. A first busbar 14 is conductively connected to the first layer 12. The window assembly 1 further comprises an added window 20, which is mounted in a second frame 26. A second layer 22 is adhered to the added window 20. The second layer 22 is conductive and comprises slats 30 which are conductive too. A second busbar 24 is conductively connected to the second layer 22 including the slats 30. The first and second busbar 14, 24 are connected to a voltage source 4 which is provided inside the second frame 26. Alternatively, the voltage source may be provided in the first frame 15. Preferably, the high-voltage wiring is provided at the inside of the window assembly 1 and difficult to access for a user while the added window 20 is in place, for safety reasons. A fastening member 16, such as an adhesive strip, connects the first frame 15 to the second frame 26 to position the added window 20 parallel the first window 10. Alternatively, bolt-nut connections or hinges may be used.

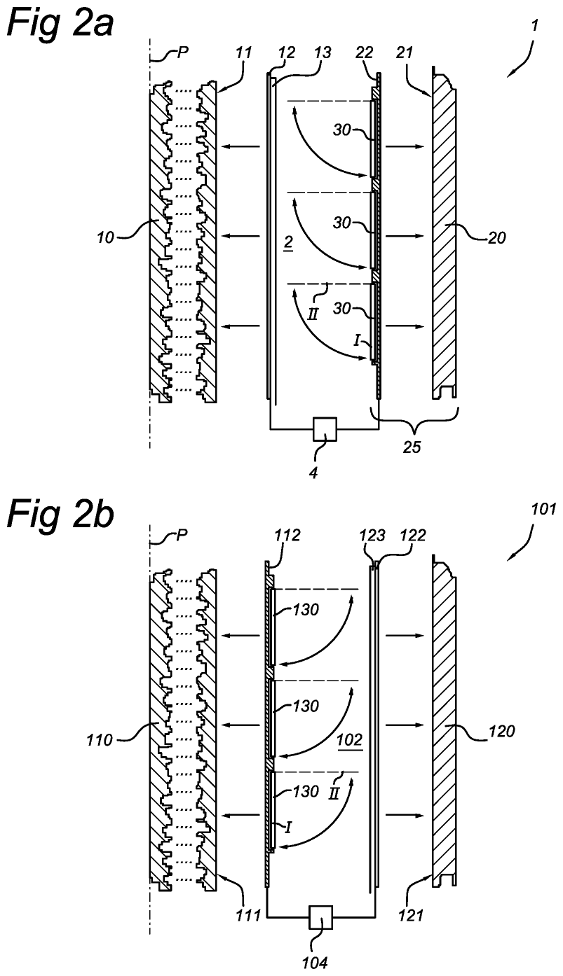

FIG. 2a shows a part of a cross-section (side view) of a window assembly 1 according to an embodiment. The window assembly 1 comprises a first window 10, which is an existing window and in this case double glass, extending parallel to a planar surface P. At the first side 11 of the first window 10, a first layer 12 is applied. The first layer 12 is conductive; it however has a surface, facing away from the first side 11, which is insulating. This may be due to a surface treatment of the conductive first layer 12, but it may also be the case that the first layer 12 comprises a conducting sublayer and an insulating sublayer 13 covering the conducting sublayer, facing away from the first side 11 of the first window 10. The first layer 12 is adhered onto the first side 11 of the first window.

The window assembly 1 further comprises an added window 20, which is a glass or plastic plate and on which a conductive second layer 22 is adhered. Together, the added window 20 and second layer 22 may be referred to as added window assembly 25. The second layer 22 comprises slats 30, which are parallel strips, at one lateral side connected to the surface part of the second layer 22, such that they can pivot between a first position I in which the slats are parallel to the surface P and a second position II in which they are perpendicular to the surface P. The second layer 22 is facing the first window 10.

In order to build an electrostatic field between the first layer 12 and the slats 30, the conductive side of the first layer 12 and the second layer 22 are connected to opposite polarities of a voltage source 4, which is schematically drawn in the figure. Electrostatic forces between the first layer 12 and the slats 30 allow the slats 30 to move depending on the voltage applied with the voltage source 4. The space 2 between the first layer 12 and the second layer 22, in which the slats 30 can move, may be at atmospheric pressure.

FIG. 2b shows a part of a cross-section of an alternative window assembly 101 according to an embodiment. The window assembly 101 is roughly similar to the window assembly 1 of FIG. 2a: it comprises a first window 110 of double glass, defining a surface P. At a first side 111 of the first window 110 a conductive first layer 112 is applied. Other than in FIG. 2a, here the first layer 112 comprises slats 130 which are parallel strips, pivotable between a first position I in which the slats are parallel to the surface P and a second position II in which they are perpendicular to the surface P.

The window assembly 101 further comprises an added window 120, at its first side 121 provided with a conductive second layer 122, comprising an insulating sublayer 123 facing away from the first side 121. A voltage source 104 is used to build an electric field between the first layer 112 and the second layer 122. The space 102 between the first layer 112 and the second layer 122, in which the slats 130 can move, may be at atmospheric pressure.

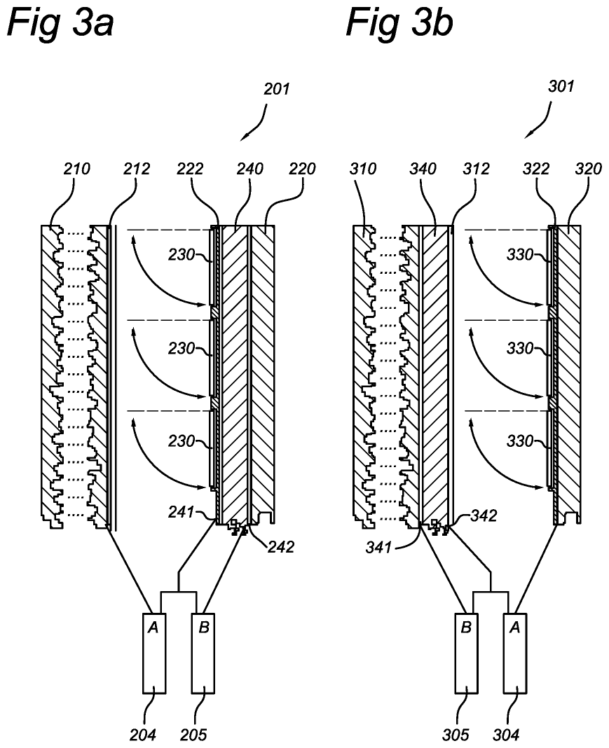

FIGS. 3a-b show parts of cross-sections of alternative window assemblies 201, 301 according to embodiments. FIG. 3a shows a window assembly 201 similar to the window assembly 1 in FIG. 2a, including a first window 210, an added window 220, a first layer 212, and a second layer 222 including slats 230. In between the second layer 222 and the added window 220, a functional layer 240 is provided, in this case a PDLC layer 240. The PDLC layer 240 is provided with electrodes 241, 242 which are intended to exert an electric field across the PDLC layer 240. In this case, the conductive sublayer 241 of the second layer 222 coincides with the electrode 241 at one side of the PDLC layer 240. The presence of the PDLC layer 240 allows for additional options for controlling the transmission of light through the window assembly 201. Separate voltage sources 204, 205 with switches allow for controlling the slats 230 and the PDLC layer 240, respectively. The first voltage source 204 serves to build an electric field between the first and second layers 212, 222 such that the movement of the slats 230 is controlled. The positive electrode of the first voltage source 204 coincides with the positive electrode of the second voltage source 205 leading to the electrode 241 at one side of the PDLC layer 240. Alternatively, the negative electrodes coincide. A voltage divider may be used as an alternative to the present configuration.

FIG. 3b shows a similar window assembly 301. Only difference is that the PDLC layer 340 is now provided in between the first window 310 and the first layer 312, i.e. opposite to the added window 320 with the second layer 322 including the slats 330. Again, electrodes 341, 342 are provided with the PDLC layer 340 at either side. One electrode 342 now coincides with the conductive sublayer 342 of the first layer 312. Separate voltage sources 304, 305 with switches allow for controlling the slats 330 and the PDLC layer 340, respectively. The voltage sources 304, 305 are positioned in a similar manner as described in FIG. 3a.

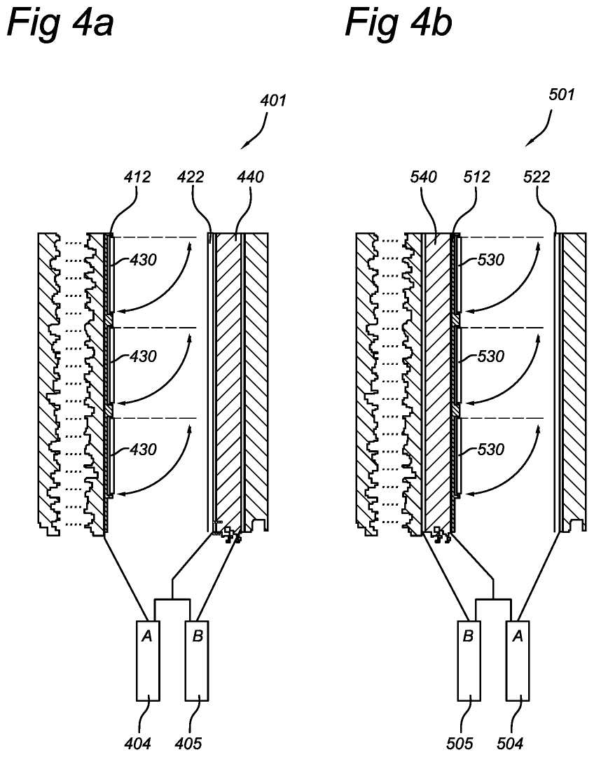

FIGS. 4a-b schematically shows cross-sections of window assemblies 401, 501 with PDLC layers 440, 540, which are equivalent to those shown in FIGS. 3a-b, but now the slats 430, 530 are provided in the first layers 412, 512, rather than in the second layers 422, 522. The person skilled in the art will understand that the various features shown in FIGS. 4a-b and their advantages correspond to those in FIGS. 3a-b.

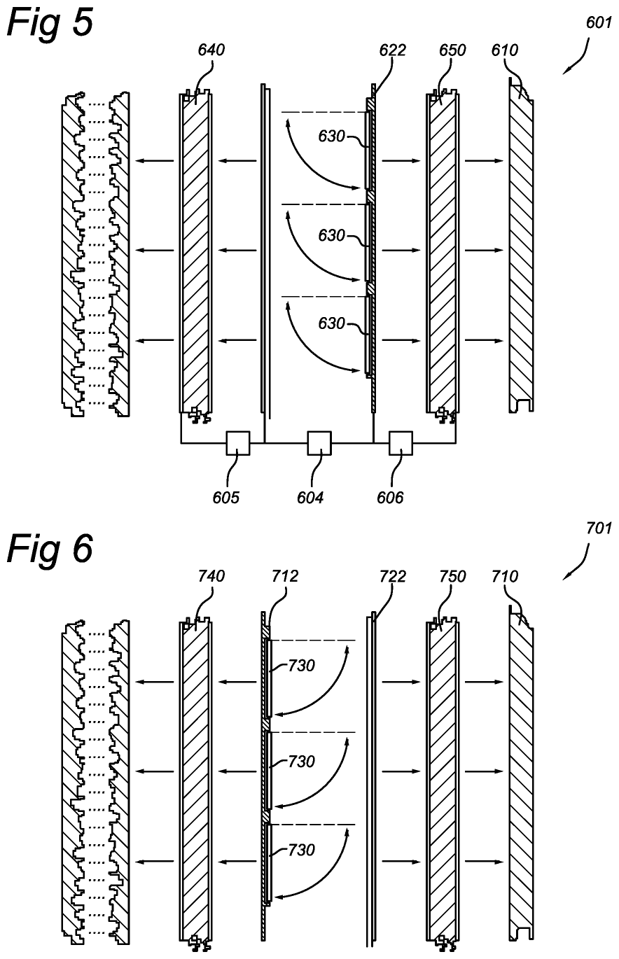

FIG. 5 shows a window assembly 601 which is very similar to the one shown in FIG. 3b, but now an extra functional layer 650 is added to the assembly 601. The extra functional layer 650 is provided in between the second layer 622 and the added window 610. Both functional layers 640, 650 can be controlled independently. The functional layers 640, 650 may be identical. Alternatively, they may have a different spectral response, or they may be functional layers of a different type. Voltage sources 604, 605, 606 allow for the control of the functional layers 640, 650 and the slats 630.

FIG. 6 shows a similar window assembly 701 as those in FIG. 5, but now the slats 730 are provided in the first layer 712 rather than in the second layer 722. Apart from that, the same features are present and the same advantages apply.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. It will be apparent to the person skilled in the art that alternative and equivalent embodiments of the invention can be conceived and reduced to practice. All changes which come within the meaning and range of equivalency of the claims are to be embraced within their scope.

1. A window assembly (1) with slats (30), comprising
a first window (10), defining a surface (P);
a first layer (12), conductive and adhered to a first side (11) of the first window (10);
an added window (20), connected to the first window (10) at the first side (11), extending parallel to the first window (10);
wherein a second layer (22) is adhered to the added window (20), the second layer being conductive and adhered to a first side (21) of the added window (20) which faces the first layer (12);
and wherein either the first layer (12) or the second layer (22) comprises slats (30) which are conductive and movable between a first position (I) in which the slats (30) extend substantially parallel to the surface (P), and a second position (II) in which the slats (30) are oriented substantially perpendicular to the surface (P), and are positioned in between the first layer (12) and the second layer (22);
and wherein the first layer (12) and the second layer (22) are connectable to a voltage source (4) for applying a voltage difference between the first layer (21) and the second layer (22), such that the slats (30) are movable.

2. The window assembly (1) according to claim 1, wherein the added window (20) is releasably connected to the first window (10).

3. The window assembly (1) according to claim 1, wherein the voltage difference is variable.

4. The window assembly (1) according to claim 1, wherein the first layer (12) or the second layer (22), whichever is opposite to the slats (30), is provided with an insulating sublayer (13) covering a surface facing the slats (30).

5. The window assembly (1) according to claim 1, wherein the added window (20) is hingedly connected to the first window (10).

6. The window assembly (1) according to claim 1, further comprising a functional layer (40), for instance a PDLC layer or a ferro-electric layer.

7. The window assembly (1) according to claim 6, wherein the functional layer (40) is provided between the first window (10) and the first layer (12), and wherein the window assembly (1) is further provided with an extra functional layer (50), for instance a PDLC layer or a ferro-electric layer, wherein the extra functional layer is provided between the added window (20) and the second layer (22).

8. The window assembly (1) according to claim 6, wherein the functional layer (40) is provided between the first window (10) and the first layer (12) or between the added window (20) and the second layer (22).

9. The window assembly (1) according to claim 6, wherein the functional layer (40) is a PDLC layer (240), which is at both lateral sides provided with electrodes (241, 242) for exerting an electric field across the PDLC layer (240), wherein the electric field is adapted to shift an optical transmittance of the PDLC layer (240) between transparent and opaque.

10. The window assembly (1) according to claim 1, wherein the voltage source (2) is provided in a frame (15) of the first window (10) or in a frame (26) of the added window (20).

11. The window assembly (1) according to claim 1, wherein the slats (30) are adapted to entirely or partially block, reflect or convert at least one of visible light, infrared radiation and ultraviolet radiation.

12. Added window assembly (25), comprising an added window (20) and a second layer (22), adapted for application in the window assembly (1) according to claim 1, wherein the second layer (22) is conductive and adhered to the added window (20), and wherein the added window (20) comprises slats (30) which are conductive and movable between a first position (I) in which the slats (30) extend substantially parallel to the added window (20), and a second position (II) in which the slats are oriented substantially perpendicular to the added window (20).

13. Assembly of conductive slats (30) provided with an adhesive second layer (22), adapted to be used in the window assembly (1) according to claim 1.

14. Method for applying slats (30) to a first window (10), comprising the steps of
providing a first window (10) provided with a conductive first layer (12) at a first side (11) of the first window (10), and providing an added window (20) provided with a conductive second layer (22) at a first side (21) of the added window (20), wherein the first layer (12) or the second layer (22) is provided with slats (30) which are conductive and are, as a result of voltage difference, movable between a first position (I) wherein the slats (30) substantially extend along a surface (P), and a second position (II) wherein the slats (30) are oriented substantially perpendicular to the surface (P), and are positioned in between the first layer (12) and the second layer (22);
placing the added window (20) parallel to the first window (10), wherein the first side (21) of the added window (20) faces the first side (11) of the first window (10);
connecting the first layer (12) and the second layer (22) to a voltage source (4) for regulating a voltage difference between the first and the second layer (12, 22).

15. The method for applying slats (30) to a first window (10) according to claim 14, further comprising, prior to the steps of claim 14, the following steps:
providing the first window (10);
applying the first layer (12) to the first side (11) of the first window (10);
providing the added window (20);
applying the second layer (22) to the first side (21) of the added window (20).

16. Method for replacing slats (30) in a window assembly (1) according to claim 2, comprising the steps of:
releasing and removing the added window (20);
removing the first or second layer (12, 22), whichever is provided with the slats (30);
applying a new first layer to the first window (10) or a new second layer to the added window (20), wherein the new first layer or the new second layer comprises slats (30);
replacing the added window (20) in the added window's original position.

17. The window assembly (1) according to claim 2, wherein the voltage difference is variable.

18. The window assembly (1) according to claim 2, wherein the first layer (12) or the second layer (22), whichever is opposite to the slats (30), is provided with an insulating sublayer (13) covering a surface facing the slats (30).

19. The window assembly (1) according to claim 3, wherein the first layer (12) or the second layer (22), whichever is opposite to the slats (30), is provided with an insulating sublayer (13) covering a surface facing the slats (30).

20. The window assembly (1) according to claim 2, wherein the added window (20) is hingedly connected to the first window (10).
